(19) United States
(12) Patent Application Publication
(10) Pub. No.: US 2014/0370836 A1
(43) Pub. Date: Dec. 18, 2014

(54) System Utilizing A Combination For Including Information Within An Outbound Communications Channel Of A Mobile Telephony-Capable Computing Device

(71) Applicant: SECURE COUTURE, LLC, Weston, FL (US)

(72) Inventor: Alexander Gladstone, Weston, FL (US)

(21) Appl. No.: 14/373,435

(22) PCT Filed: Jan. 21, 2013
(86) PCT No.: PCT/US2013/022424

§ 371 Date: Jul. 21, 2014

Related U.S. Application Data
(60) Provisional application No. 61/632,447, filed on Jan. 24, 2012.

(51) Int. Cl. H04M 11/04

(52) U.S. Cl. CPC H04M 11/04
USPC 455/404.1

(57) ABSTRACT

A system and combination for accessing an emergency network through a commercially available off-the-self (COTS) mobile telephony-capable computing device (10).

Applicant claims priority to PCT Application US2013/022424, filed Jan. 21, 2013 entitled—System Utilizing a Combination for Including Information Within an outbound Communication Channel of a Mobile Telephony-Capable Computing Device—.

### BACKGROUND OF THE INVENTION

1. Field of the Invention

Among other things, the present invention includes a system for accessing an emergency network through a commercially available off-the-self (COTS) mobile telephony-capable computing device (10).

2. Summary of the Invention

Unlike prior art systems, the current invention supplies one or more applications and peripherals capable of accessing a communication channel of a commercially available off-the-self (COTS) mobile telephony-capable computing device to cause the communication channel to carry information to a site remote from the COTS mobile telephony-capable computing device.

Select preferred aspects the current combination and system enable a COTS mobile telephony capable computing device (MCTD) to accomplish one or more of the following:

Utilize a program that causes the MCTD to transmit information to a location remote from the MCTD via an outbound communication channel formed between the MCTD and a network;

Utilize a program managed by a processor of the MCTD to initiate the formation of an outbound communication channel formed between the MCTD and a network;

Utilize a program managed by a processor of the MCTD to provide at least one piece of information to an outbound communications channel formed between the MCTD and a network;

Communicate information to a location remote from the MCTD irrespective of the user's ability to communicate verbally;

Communicate information to a location remote from the MCTD irrespective of the user's ability to interact physically with user interface(s) of the MCTD;

Provide information to a Public-Safety Answering Point (PSAP) during an emergency;

Provide false-alarm information to a location remote from the MCTD;

Provide duress information to location remote from the MCTD;

Provide information to multiple locations remote from the MCTD via multiple communications channels including an outbound voice communications channel of the MCTD; and/or

Provide a user with a peripheral device that provides the user with information communication capabilities via an outbound voice communications channel of the MCTD.

A preferred embodiment of the current invention can be described as a combination for providing an information-carrying transmission to an audio communications channel established between a commercially available off-the-self (COTS) mobile telephony-capable computing device (MTCD) (10) and a remote communications endpoint (RCE) via a network (99): a) the MTCD (10) comprising: a MTCD (10) processor, a MTCD (10) memory, a power source, an audio interface (11), a wired peripheral interface (12), a wireless peripheral interface (13), a network interface (15), one or more programs (16) and operating system hardware interface layers (17); b) the combination further comprising: i) one or more wireless peripheral devices (20), wherein at least one of the wireless peripheral devices (20) comprises: an application processor (50), a wireless communications physical layer (33), an inter-process communications means (26), an optional audio source (28), an energy source and an antenna (41); ii) one or more logical peripherals (21,23), wherein the logical first and second peripherals (21, 23) are capable of: communicating with the inter-process communications means (26), the application processor (50) and the operating system hardware interface layers (17); and A) wherein at least one of the first logical peripherals (21) is capable of communicating an audio signal to the MTCD's outbound voice communication channel and exchanging data with one or more logical second peripherals (23); and B) wherein at least one of the logical second peripherals (23) can exchange data with one or more of the programs (16) and one or more of the first logical peripherals (21) causing one or more of the programs (16), one or more of the first logical peripherals (21) and/or the at least one logical second peripheral (23) in communication with the operating system hardware interface layers (17) to generate audio information such that subsequent to generation of the audio information the logical first peripheral (21) communicates the audio signal to the MTCD's (10) outbound voice communication channel for carrying the audio signal to the RCE, and wherein the audio signal includes at least one piece of information received by the logical second peripheral (23) from the MTCD (10); and iii) optionally, a wired peripheral device (30) comprising a wired communication physical layer (36), an inter-peripheral communications link (25), inter-process communications link (26), an optional audio source (28), an application processor (50), an energy source and one or more logical peripherals (21,23), wherein the wired peripheral device (30) is capable of communicating with the operating system hardware interface layers (17); and/or iv) optionally, an audio jack peripheral (39) comprising a digital-analog converter (27), an inter-peripheral communications link (25), inter-process communications link (26), an optional audio source (28), an application processor (50), an energy source and one or more logical peripherals (21, 23), wherein the audio jack peripheral (39) is capable of communicating with the operating system hardware interface layers (17).

Another preferred embodiment of the current invention can be described as an emergency communications access for mobile user (ECAM) system for initiating one or more outbound communications transmitting textual and/or verbal communications to one or more RCEs over one or more networks (99), wherein the ECAM utilizes the previous above disclosed and enabled combination.

It is the novel and unique interaction of these simple elements which creates the combination and system, within the ambit of the present invention. Pursuant to the Articles of the Patent Cooperation Treaty, select preferred embodiments of the current invention follow. However, it is to be understood that the descriptions of the preferred embodiments do not limit the scope of the present invention.

### BRIEF DESCRIPTION OF THE DRAWINGS

FIG. 1 is an illustration of a preferred embodiment of a mobile telephony-capable computing device (MTCD) 10 with multiple peripherals.

FIG. 2A illustrates a preferred embodiment of a MTCD 10 wireless physical peripheral device 20.

FIG. 2B illustrates a preferred embodiment of a MTCD 10 wired physical peripheral device 30.

FIG. 2C illustrates a preferred embodiment of a MTCD 10 audio jack peripheral device 39. FIG. 3 illustrates a preferred embodiment of a novel inventive combination of the current system utilizing a physical peripheral device 20 communicating wirelessly with MTCD 10 that includes logical first peripheral 21 and logical second peripheral 23.

FIG. 4 illustrates a preferred embodiment of a novel inventive combination of the current system where wireless peripheral device 20 communicates indirectly with a software program 16 of MTCD 10 by forming a first wireless inter-peripheral communications link 25 with logical second peripheral 23 contained within a physical peripheral device 30 in wired communication with MTCD wired peripheral interface 12 of MTCD 10.

FIG. 5 illustrates a preferred embodiment of a novel inventive combination of the current system where a wireless peripheral device 20 communicates with a software program 16 of MTCD 10 via a MTCD wireless peripheral interface 13 and communicates with a wired peripheral device 30 by forming a wireless inter-peripheral communications link 25 with a logical second peripheral 23 associated with peripheral device 30 in wired communication with MTCD wired peripheral interface 12 of MTCD 10.

FIG. 6 illustrates a preferred embodiment of a novel inventive combination of the current system where a wireless peripheral device 20 communicates with a software program 16 of MTCD 10 via a MTCD wireless peripheral interface 13 and communicates with an audio jack peripheral device 39 by forming a wireless inter-peripheral communications link 25 with a logical second peripheral 23 contained within peripheral device 39 in wired communication with MTCD analog input and analog-digital converter block 11 of MTCD 10.

FIG. 7 illustrates a preferred embodiment of a novel inventive combination of the current system where a wired peripheral device 30 communicates with a software program 16 of MTCD 10 via a MTCD wired peripheral interface 12 and can communicate with a wireless peripheral device 20 by forming a wireless inter-peripheral communications link 25 with a second peripheral 23 associated with wireless peripheral device 20.

FIG. 8 illustrates a preferred embodiment of a novel inventive combination of the current system where an audio jack peripheral device 39 communicates with a software program 16 of MTCD 10 via MTCD data-over-audio interface 14 utilizing peripheral digital-analog converter block and analog audio output 27 (as embodied in FIG. 8, the functional equivalent of a logical first peripheral 21) in communication with an MTCD analog input and analog-digital converter block 11.

FIG. 9 illustrates a preferred embodiment of a novel inventive combination of the current system where a wired peripheral device 30 communicates with a software program 16 of MTCD 10 via a MTCD wired peripheral interface 12 and also communicates with an audio jack peripheral device 39 by forming a wired inter-peripheral communications link 25 with logical second peripheral 23 associated with device 39 in wired communication with MTCD analog input and analog-digital converter block 11 of MTCD 10.

FIG. 10 illustrates an emergency communication access for mobile users (ECAM) system.

FIG. 11 illustrates a call establishment sequence describing the establishment of a telephone call using preferred embodiments of the current system.

### DESCRIPTION OF THE PREFERRED EMBODIMENTS

Preferred Embodiments of Combinations Utilized by the Current System

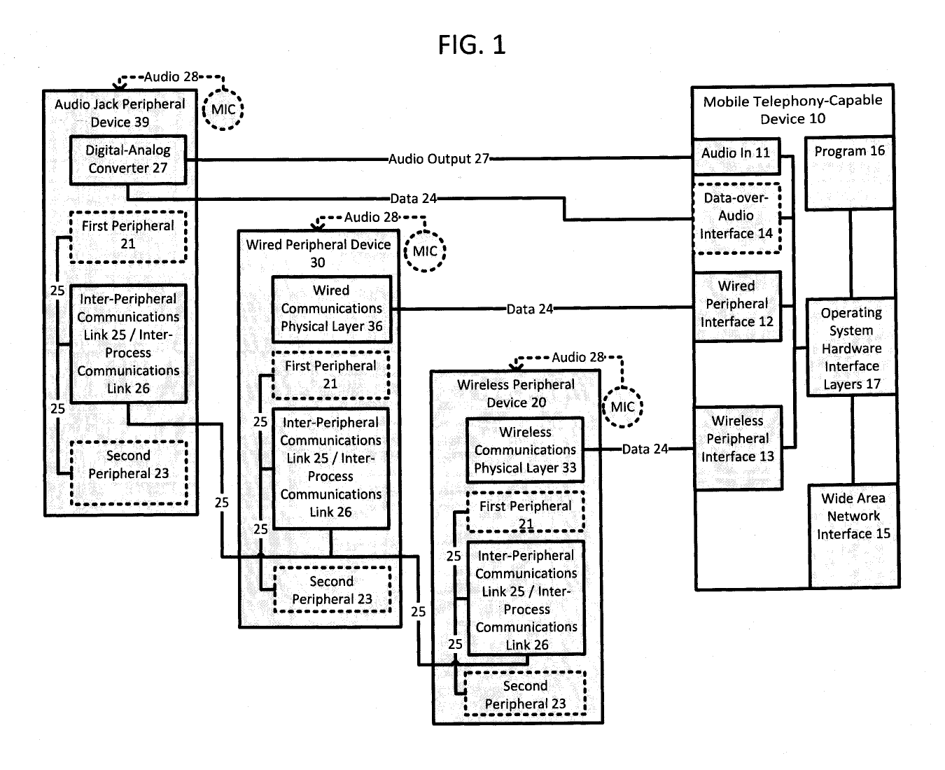

Various preferred embodiments of the current system combine a (Commercial-Off-The-Self) COTS mobile telephony-capable computing device (MTCD) 10 with one or more MTCD physical peripheral devices (20, 30, 39). FIG. 1 illustrates an embodiment of a MTCD 10 in communication with different exemplary embodiments of MTCD peripheral devices (20, 30, 39). Each MTCD physical peripheral device (20, 30, 39) can include one or more logical first peripherals 21 and/or one or more logical second peripherals 23. Some examples of COTS wireless and wired peripheral devices (20, 30, 39) compatible with the current system can include audio jack devices, wearable headsets, stationary or portable hands-free telephony interfaces, interfaces such as keyboards, mice, buttons and/or knobs interfaces, audio recording and playback interfaces, wearable motion sensors, location sensors, health monitoring devices, and other MTCDs when operated as network peer devices in communication with MTCD 10.

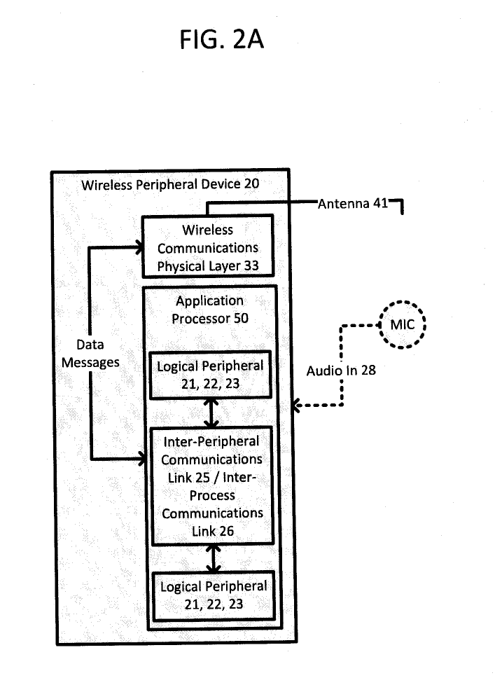

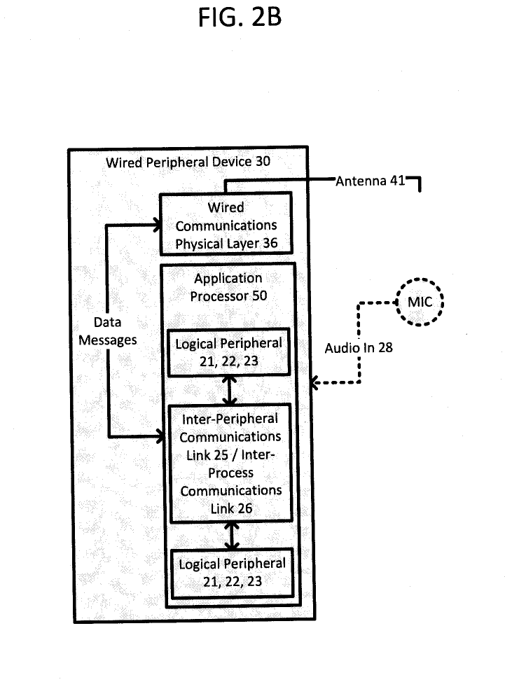

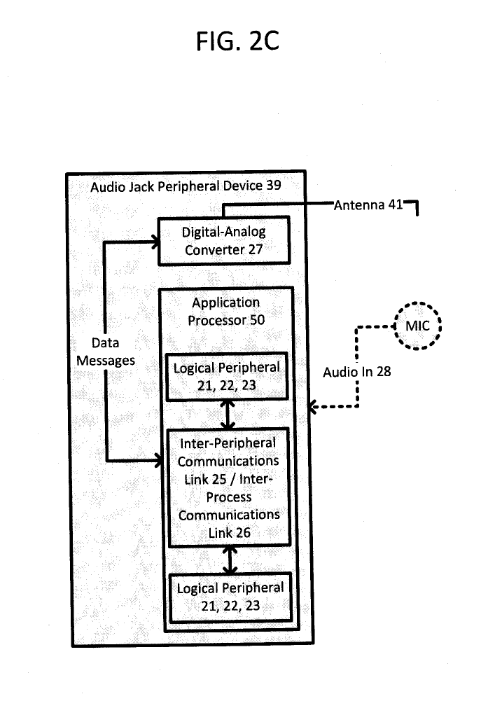

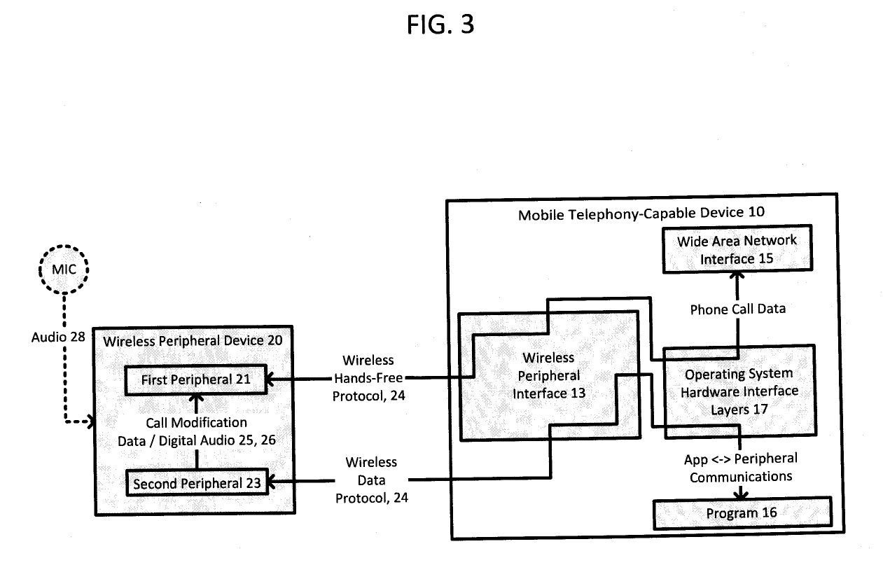

Although not explicitly illustrated in FIG. 1, preferred embodiments of MTCD 10 can employ wired and/or wireless peripheral communications links that enable both data and hands-free communication messages to be sourced from and/or destined for one or more software or hardware entities residing within MTCDs 10 and/or physical peripheral devices (20, 30, 39). In select preferred embodiments, the logical separation of concerns within physical peripheral devices (20, 30, 39) into hands-free communications concerns and/or data message handling concerns constitute logical first and second peripherals (21, 23). Each MTCD physical peripheral device (20, 30, 39) can contain an inter-peripheral communications link 25. Logical first peripherals 21 and second peripherals 23 can utilize physically independent hardware and/or share some or all of the same physical hardware resources. When logical peripherals 21 and 23 share hardware resources, the peripherals can be represented at least in part by logical peripheral programs executable by a common processor 50 as depicted in FIG. 2. Although a wireless peripheral 20 is illustrated in FIG. 2, within the scope of the current system, a wired peripheral 30 or audio jack peripheral 39 can also utilize processor 50, logical peripherals 21, 22, 23, inter-process communication means 26 and a communications layer. The inter-peripheral communications link 25 can be formed by an inter-process communications means acceptable in the art. Each MTCD physical peripheral device (20, 30, 39) can include one or more peripheral-MTCD communications links 24 and/or one or more inter-peripheral communications links 25.

Select preferred embodiments of peripheral-MTCD communications links 24 and inter-peripheral communications links 25 can utilize communications links such as Bluetooth™, Wi-Fi™, Zigbee™, Near-Field Communications (NFC), infrared, USB, UART, proprietary-type dock port standards including but not limited to the Apple™ Dock Connector, as well as other communications means acceptable in the art such as over-the-air and over-the-wire audio-frequency communications techniques. Application-level protocols can be utilized to enhance implementation of communications links 24 and 25. Examples of application-level protocols are the provision of: data packet sequence numbering and guaranteeing in-order arrival of data packets, cyclic redundancy checks and/or checksums, error correction such as data parity checking, forward error correction, block coding, data compression, and/or data encryption. For select preferred embodiments of the current system, information signals included within outbound voice communications channels can constitute a physical communication channel and can be enhanced to include logically separate communication channels and/or to employ any combination of application-level protocols, error detection or correction mechanisms, compression, encryption, and the like.

In select preferred embodiments of the current system illustrated in FIG. 1, MTCD physical peripheral devices (20, 30, 39) can include an audio source 28 not limited to analog and digital audio recording and playback devices, audio pressure-sensitive transducers, and microphones. Many commercially available MTCD physical peripheral devices (20, 30, 39) provide additional sensors and sensor data to MTCDs beyond simple microphones and can provide additional information to locations remote from the user and MTCD 10. Examples of additional sensors include: battery-life sensors and other device self-diagnostic sensors, user biomedical factor sensors such as heart-rate sensors, pulse-oximeters, blood glucose monitors, electrical skin impedance monitors, geographical position sensors such as global positioning system (GPS) sensors, multiple-axis accelerometers and shock sensors, imaging sensors, or video sensors. Programs 16 executing on the MTCD 10 can include one or more third party programs 16 controlling third party peripheral devices, and for storing, processing and/or communicating sensor information received from supported devices to second peripherals 23 or other peripherals. Select preferred embodiments of MTCDs 10 can support intercommunications between multiple programs, i.e., programs 16 can intercommunicate with one or more programs and can indirectly collect information from local sensors proximate other programs 16, local area or wide area network sources and can indirectly disseminate information to other destinations by communicating with other programs using available intercommunications means.

As illustrated in FIG. 1, select preferred embodiments of MTCD 10 contain an MTCD analog input and analog-digital converter block 11. MTCD physical peripheral device 39 can be provided with a peripheral digital-analog converter block and analog audio output 27 connected to converter block 11 of MTCD 10 to supply audio to converter block 11 during an outbound voice communication. In such a configuration, block 27 also functions as a logical first peripheral 21. Other examples of logical first peripherals 21 can include software associated with wired and wireless hands-free devices such as wired headphones with microphones, and Bluetooth™ wireless headsets.

A processor of MTCD 10 is capable of managing and executing one or more third party programs 16. Non-limiting examples of third party applications include games, social networking applications, alternative web browsers, alternative media players, Voice-over-IP and other communications and messaging applications.

Programs 16 can be compatible with a specific operating system and/or processor of a COTS MTCD 10 and may be developed by others than the manufacturers of COTS MTCD 10 or the software operating system supporting programs 16. Within the scope of the current system, MTCD 10 can utilize operating systems and variants of the Apple iOS™, Symbian™ OS, Palm™ OS, Palm/HP WebOS™, Google Android™ OS, embedded Linux™ or Unix™, QNX™ operating system, Windows Mobile™ OS and/or Windows Phone™ OS. Programs 16 running on an operating system associated with MTCD 10 can be restricted by an operating system or variant from directly communicating with hardware and logical peripherals (21, 23) of the MTCD 10. If such a restriction occurs, an operating system can provide access through a series of software constructs as shown in FIGS. 3-10 and identified herein as the MTCD operating system hardware interface layer 17. System restrictions of programs 16 by an operating system can limit communication with peripheral devices unless communication is supported by the combination of the MTCD operating system hardware interface layer 17 and operating system.

For some preferred embodiments of the current system illustrated in FIG. 1, implementation of a COTS MTCD 10 does not allow multiple peripherals to interact with MTCD 10 programs at substantially the same time, thereby interfering with timely transition between MTCD 10 communications with logical second peripheral 23 and/or logical first peripheral 21. Communication of data with each peripheral can be sequenced in real time or delayed. Support for delayed communication can require physical peripheral devices (20, 30, 39) to contain memory (volatile and/or non-volatile memory) sufficient to buffer and/or store information received or derived from logical second peripheral 23 until such time as logical first peripheral 21 can present an audio signal to MTCD 10.

In certain preferred embodiments of the system of FIG. 1, MTCD 10 runs an operating system that allows third party programs 16 to be automatically loaded for execution when the MTCD is powered on. In still other preferred embodiments, MTCD 10 runs an operating system that can restrict one or more programs or applications from being loaded when the MTCD 10 is powered on. When an operating system prevents program 16 from automatically loading in the MTCD 10, the user can manually start program 16. In still other preferred embodiments, a proprietary authentication or authorization chip compatible with MTCD 10 can be included in one or more wired or wireless peripherals. The authentication or authorization gives program load command capabilities to the peripheral, e.g., peripheral device 20 can, in response to user action or to a periodic awakening, from a low-power state, create a peripheral-MTCD communications link 24 and subsequently send messages to MTCD 10 over link 24 in accordance with the proprietary authorization and command protocols of MTCD 10 requesting the execution of program 16. In other preferred embodiments of the current system, the user of MTCD 10 utilizes the user interface of a MTCD 10 operating system and causes the operating system to cease operating program 16 and program 16 is removed from operating memory. Mechanisms disclosed herein can be employed to reload program 16. Program 16 can enqueue or transmit an electronic notification addressed to the MTCD user between the time the operating system requests program 16 to unload and the unloading of program 16 such that MTCD 10 notifies the user of the dangers associated with unloading program 16 and suggests that program 16 be restarted. In an another preferred embodiment of the system, a network computer or server remote from MTCD 10 communicates with program 16 and sends a notification to the MTCD user of potential dangers of a shutdown of program 16 when program 16 fails, fails to respond to server polling and/or receives a communication from program 16 upon unload.

FIG. 2A illustrates a preferred embodiment of a MTCD physical peripheral device 20 forming two wireless peripherals represented by two logical peripheral program products (21, 23) executing on applications processor 50 suitable to communicate with and provide for logical peripheral shared access to a wireless communications physical layer module 33. The logical peripheral applications (21, 23) as illustrated in FIG. 2 employ inter-process communications 26. Wireless communications physical layer module 33 provides wireless transmission and reception according to one or more wireless communications specifications such as but not limited to Bluetooth™ communications channels. Although the illustration of

FIG. 2A shows two logical peripherals (21, 23) executed within a single application processor 50 and sharing a common wireless communications physical layer 33 hardware resource, in other preferred embodiments, any number of logical peripherals (21, 22, 23) can be executed on any number of application processors 50 and can share any number of hardware resources.

FIGS. 2B and 2C are illustrative of preferred embodiments of a wired peripheral device 30 and an audio jack peripheral device 39 that are functional with the current system.

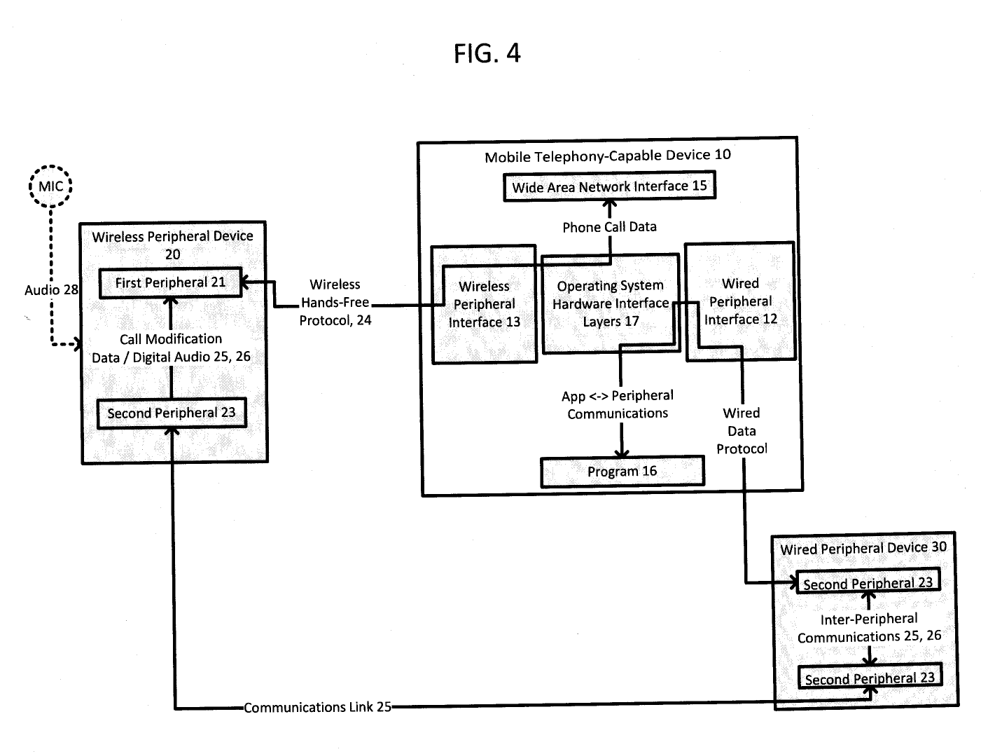

FIGS. 3-11 illustrate various preferred embodiments of the current system using different novel inventive combinations of wireless, wired and audio jack physical peripheral devices (20, 30, 39) containing different quantities of logical first and second peripherals (21, 22, 23). Although FIGS. 3-11 show a MTCD wired peripheral interface 12, a MTCD wireless peripheral interface 13 and a MTCD data-over-audio interface 14, the use of multiple interfaces 12, 13 and 14 are within the scope of the current novel inventive combination associated with the present system. When utilizing multiple interfaces 12, 13 and 14, peripheral-MTCD communications links 24 can be implemented using physically different communications specifications and can be formed by MTCD 10 using one or more shared or unshared MTCD peripheral interfaces 12, 13, and 14. Although the illustrations depict MTCD 10 showing a single MTCD Wireless or Wired Wide-Area Network (WWAN) interface 15, MTCD 10, via a network 99, can form outbound communication channels with remote communications endpoints (RCEs) employing multiple interfaces 15. Although FIGS. 4-8 depict one or more physical peripheral devices (20, 30, 39) including one or more second peripherals 23 to support an inter-peripheral communications link 25, links 25 can be managed by incorporating control functionality into one logical second peripheral 23 associated with a peripheral device (20, 30, 39) where the logical second peripheral 23 communicates with MTCD 10 via peripheral-MTCD communications link 24 and with another logical second peripheral device 23 via an inter-peripheral communications link 25.

FIG. 3 illustrates a preferred embodiment of a novel inventive combination of the current system utilizing a physical peripheral device 20 communicating wirelessly with MTCD 10 that includes logical first peripheral 21 and logical second peripheral 23. MTCD program 16 communicates with logical second peripheral 23 via the MTCD operating system hardware interface layer 17 that controls access to MTCD wireless peripheral interface 13. The FIG. 3 embodiment can include an optional microphone element that functions as a peripheral user-generated audio source 28. In a preferred embodiment, audio received from source 28 by a processor 50 of wireless peripheral device 20 is sent over the logical second peripheral's 23 peripheral-MTCD communications link 24 to program 16 that processes the audio to generate information-including audio signal data and returns the information to logical second peripheral 23 over link 24 where the information is subsequently forwarded to logical first peripheral 21 via an inter-peripheral communications link 25. In another preferred embodiment, the information-including audio signal data is further processed by logical second peripheral 23 before the information is sent to logical first peripheral 21 via an inter-peripheral communications link 25. Logical first peripheral 21 can use information received from logical second peripheral 23 and/or information stored within an electronic memory store in communication with a processor of MTCD 10 or physical peripheral device 20 to perform activities in conjunction with MTCD 10. Examples of the combined actions of logical first peripheral 21/second peripheral 23/MTCD 10 include but are not limited to: using peripheral-MTCD communications link 24 to form a hands-free compliant communications channel with a MTCD wireless peripheral interface 13; using a hands-free compliant communications channel supported by peripheral-MTCD communications link 24 to command MTCD 10 to form an outbound voice communications channel on behalf of logical second peripheral 23; and communicating information-including audio signals to a location remote from MTCD 10.

FIG. 4 illustrates a preferred embodiment of a novel inventive combination of the current-system where wireless peripheral device 20 communicates indirectly with MTCD software program 16 by forming a first wireless inter-peripheral communications link 25 with logical second peripheral 23 contained within a physical peripheral device 30 in wired communication with MTCD wired peripheral interface 12 of MTCD 10. The embodiment enabled in FIG. 4 can be beneficial when total functional bandwidth available for an implementation of wireless peripheral-MTCD communications link 24 is not sufficient to allow simultaneous transmission and reception of desired amounts of information and hands-free compliant communications. Illustrations of situations of when the FIG. 4 embodiment is particularly useful can include: the data-rate is selectable or variable and a lower data-rate must be utilized to meet engineering parameters; the protocol does not guarantee in-order delivery of data packets and provision of application-level support of packet reordering at an acceptable data-rate supported by link 24 requires additional processing capability within the physical peripheral device 20; and/or a widely-supported standard protocol such as the Bluetooth™Human-Interface Device (HID) profile is selected for communication between programs 16 and a logical second peripheral 23 because of compatibility conflicts with a MTCD 10 implementation. The preferred embodiment of FIG. 4 can also be beneficial when the hardware and/or software systems of MTCD 10 do not support formation of simultaneous communications between MTCD 10 and multiple logical peripherals via peripheral-MTCD communications links 24.

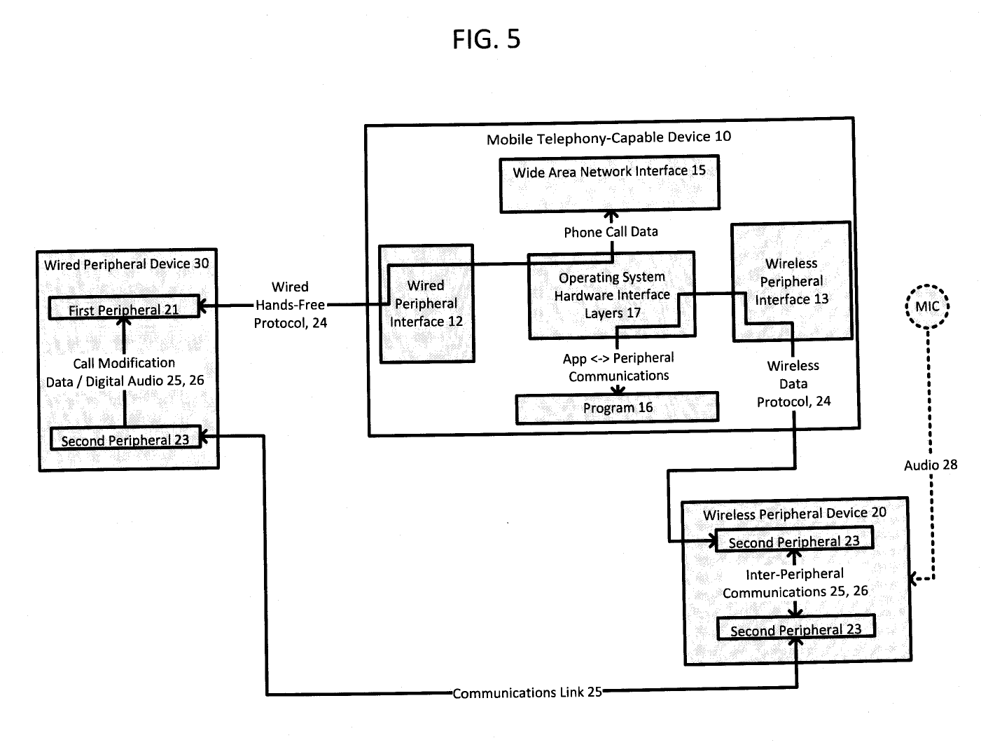

FIG. 5 illustrates a preferred embodiment of a novel inventive combination of the current system where a wireless peripheral device 20 communicates with a software program 16 of MTCD 10 via a MTCD wireless peripheral interface 13 and communicates with a wired peripheral device 30 by forming a wireless inter-peripheral communications link 25 with a logical second peripheral 23 associated with peripheral device 30 in wired communication with MTCD wired peripheral interface 12 of MTCD 10. The embodiment of FIG. 5 can be beneficial when the user cannot access MTCD 10 during an emergency and there is a desire to source user-generated audio from a wireless peripheral device 20 when the hardware or software systems of MTCD 10 do not support wireless implementation of peripheral-MTCD communications link 24 supporting logical first peripheral 21 capable of supplying at least one audio input to a voice communications channel of an outbound voice communication from MTCD 10.

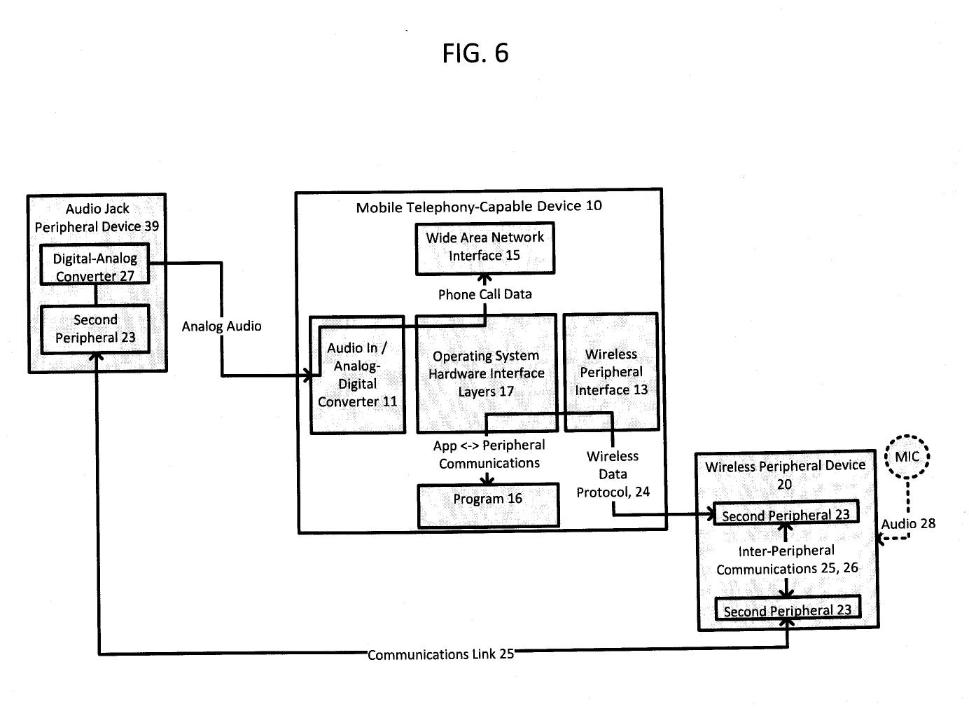

FIG. 6 illustrates a preferred embodiment of a novel inventive combination of the current system where a wireless peripheral device 20 communicates with a software program 16 of MTCD 10 via a MTCD wireless peripheral interface 13 and communicates with an audio jack peripheral device 39 by forming a wireless inter-peripheral communications link 25 with a logical second peripheral 23 contained within peripheral device 39 in wired communication with MTCD analog input and analog-digital converter block 11 of MTCD 10. As illustrated in FIG. 6, audio sourcing logical first peripheral 21 is a peripheral digital-analog converter block and analog audio output 27. The preferred embodiment of FIG. 6 can be beneficial when MTCD 10 does not provide for hands-free compliant communications between either wired or wireless links and the MTCD 10 and operating system restriction on one or more programs 16 does not prevent initiation of outbound voice communication channels.

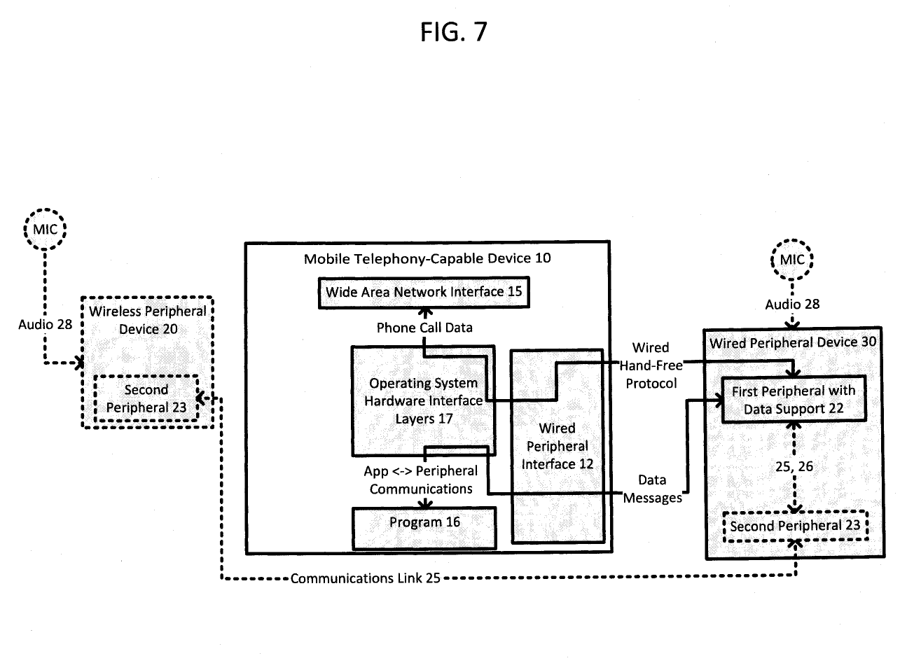

FIG. 7 illustrates a preferred embodiment of a novel inventive combination of the current system where a wired peripheral device 30 communicates with a software program 16 of MTCD 10 via a MTCD wired peripheral interface 12 and can communicate with a wireless peripheral device 20 by forming a wireless inter-peripheral communications link 25 with a second peripheral 23 associated with wireless peripheral device 20. The FIG. 7 MTCD 10 embodiment can utilize a protocol allowing peripheral device 30 to support hands-free messaging and flexible data messaging such that peripheral device 30 forwards hands-free messages to a logical first peripheral 22 and data messages to a logical second peripheral 23 via message parsing and/or routing mechanisms acceptable in the art. Preferred embodiments of the system illustrated in FIG. 7 can also be implemented such that the logical first and second peripherals (22, 23) are represented by different message handling software routines within the same embedded software application.

Preferred FIG. 7 embodiments utilizing logical second peripheral 23 supporting wireless inter-peripheral communications link 25 can be beneficial when: alternative physical wireless transmission systems, custom wireless communications protocols, or non-standard power-saving techniques are employed to increase battery life or effective transmission distance; audio may be presented to the current system via peripheral user-generated audio source 28 of wired peripheral 30 or via audio source 28 of optional wireless peripheral 20; and/or multiple audio sources 28 can be compared to implement noise-reduction with techniques acceptable in the art. As illustrated in FIG. 7, MTCD 10 supports a protocol allowing data message communication to wired peripheral device 30 to be sourced from program 16 either prior to or during engagement of peripheral device 30 in a hands-free mode of operation.

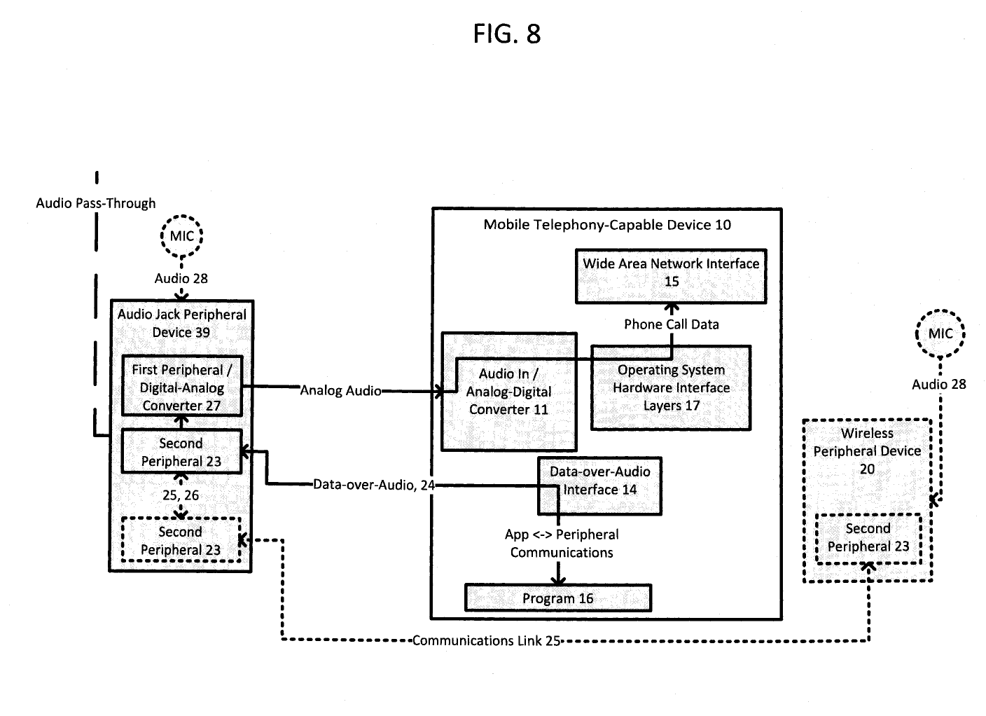

FIG. 8 illustrates a preferred embodiment of a novel inventive combination of the current system where an audio jack peripheral device 39 communicates with program 16 of MTCD 10 via MTCD data-over-audio interface 14 utilizing peripheral digital-analog converter block and analog audio output 27 (as embodied in FIG. 8, the functional equivalent of a logical first peripheral 21) in communication with an MTCD analog input and analog-digital converter block 11. In select preferred embodiments, a microphone can be a peripheral user-generated audio source 28. As shown, without physically disconnecting audio jack peripheral device 39, device 39 utilizes an audio pass-through allowing functionality of audio jack peripheral device 39 prior to activation of any logical peripheral contained in device 39.

In select preferred embodiments of the current system illustrated in FIG. 8, a wireless physical peripheral with a microphone peripheral user-generated audio source 28 communicates with logical second peripheral 23 of audio jack peripheral device 39 via wireless inter-peripheral communications link 25. The embodiment of FIG. 8 without the wireless peripheral device 39 can be beneficial when no wireless user-generated audio source is required and MTCD 10 supports forming calls at the request of program 16. When the scenario does not include a wireless peripheral device, the user is able to interact directly with MTCD 10 and program 16 is not required to form outbound voice communications channels without direct user interaction. Preferred embodiments of FIG. 8 utilizing an optional wireless inter-peripheral communications link 25 and wireless peripheral device 39 can be beneficial when the MTCD 10 does not contain a MTCD wireless peripheral interface 13; the MTCD 10 does not support a flexible communications protocol over a wireless peripheral-MTCD communications link 24; and/or the power-consumption of communications link 24 is higher than a user-generated audio and/or information-including audio signal data communicated over a wireless inter-peripheral communications link 25.

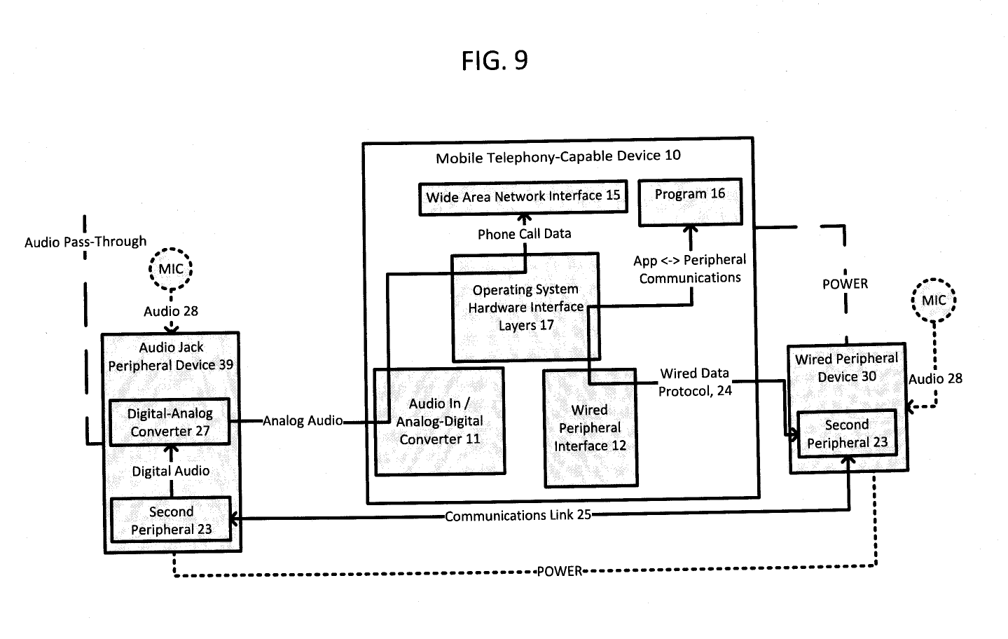

FIG. 9 illustrates a preferred embodiment of a novel inventive combination of the current system where a wired peripheral device 30 communicates with a software program 16 of MTCD 10 via a MTCD wired peripheral interface 12 and also communicates with an audio jack peripheral device 39 by forming a wired inter-peripheral communications link 25 with logical second peripheral 23 associated with device 39 in wired communication with MTCD analog input and analog-digital converter block 11 of MTCD 10. As shown, the audio sourcing logical first peripheral 21 is a peripheral analog-digital converter block and analog audio output 27. The preferred embodiment of FIG. 9 is similar to the embodiments of FIG. 6 and can be beneficial when: MTCD 10 does not provide for hands-free compliant communications over either wired or wireless peripheral links and there is no operating system restriction preventing programs 16 from initiating outbound voice communications channels without direct user intervention and/or the two physical peripheral devices (30, 39) share power derived from MTCD 10 which reduces or eliminates independent electrical energy storage, charging, or harvesting mechanisms within physical peripheral devices (30, 39).

Some of the embodiments of the current system utilizing peripheral-MTCD communications links 24 and/or inter-peripheral communications links 25 and/or WWAN communications links may be susceptible to interferences or disrupted by signal jamming devices. Because of such potential signal disruptions, select preferred embodiments of the current system can include physical peripheral devices containing RF signal interference detectors and/or audible, vibrational, or other physical alerting modules warning the user that the system is at least partially inoperable. Due to increased power usage of the signal interference detection hardware, the detection hardware can derive power from sources independent of the system or a power-sourcing means of MTCD 10 such as wired connections to USB™ ports, proprietary MTCD docking ports, and the like. In select preferred embodiments, signal interference detection can be partially or entirely provided by programs 16 in conjunction with the MTCD 10's signal monitoring capabilities. MTCD-based inherent signal interference detection can check for high levels of signal as measured by a radio resource of MTCD 10, e.g., Wi-Fi™ or WWAN signal “bars,” and one or more failed attempts to form data connections between MTCD 10 and wireless peripheral endpoints, known or discovered wireless access points, or known endpoints remote from MTCD 10 reachable via WWAN 99.

Select preferred embodiments of the current system can include a test mode of operation initiated by: a switch associated with peripheral devices (20, 30, 39); and/or user-accessible settings associated with MTCD 10 in conjunction with test programs associated with MTCD 10. Regarding a test mode program loaded in MTCD 10, the test mode program can send or respond to messages from a logical second peripheral 23 to cause a peripheral device (20, 30, 39) to enter into a diagnostics reporting mode and cause MTCD 10 to utilize a WWAN connection to check firmware numbers and/or to download new firmware revisions and/or perform “end-to-end” functional testing of peripheral devices (20, 30, 39) and MTCD 10 as if the system is initiated in a non-test mode but where the endpoint is a testing endpoint.

In accordance with the current system, firmware of peripheral applications associated with a peripheral device (20, 30, 39) can be updated/upgraded by utilizing a MTCD 10 capable of sending or responding to messages from a logical second peripheral 23. Examples of firmware updating include: signaling a peripheral device (20, 30, 39) such that it reboots and executes a firmware upgrading application that accepts new firmware memory blocks, overwrites old firmware memory blocks, checks validity of firmware memory blocks, and the like.

The Emergency Communications Access System (ECAM) Utilizing One or More Combinations

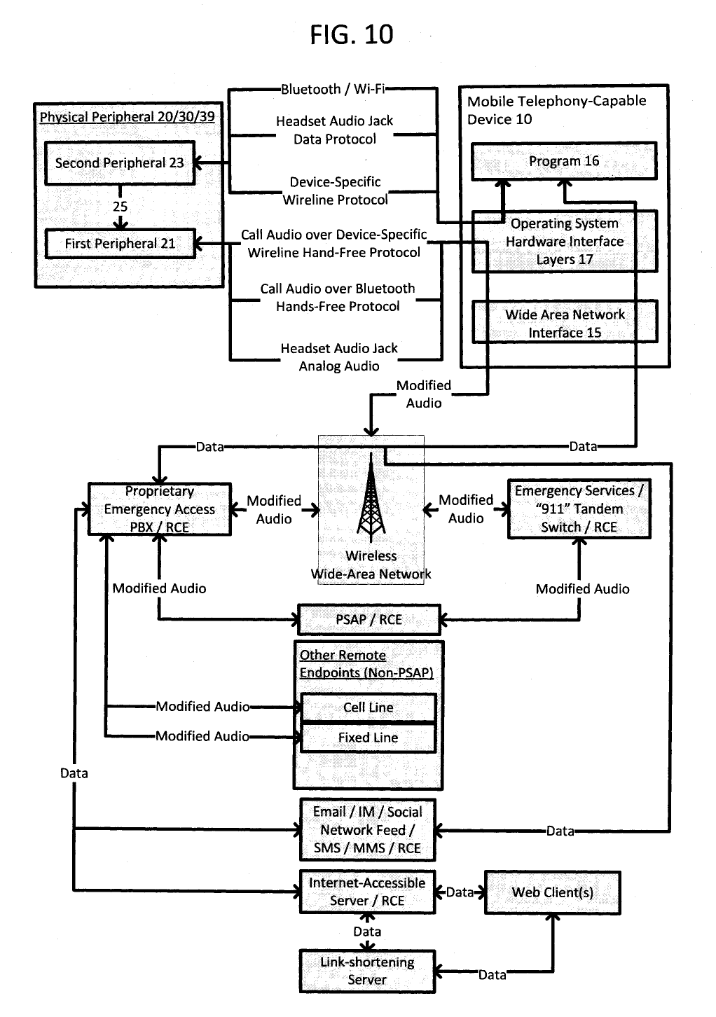

FIG. 10 illustrates an emergency communication access for mobile users (ECAM) system. The ECAM system can use one or more preferred embodiments of the MTCD 10 and/or its peripherals (20, 21, 23, 30, 39) previously enabled to allow a person-in-distress or in need of assistance to initiate one or more outbound communications channels formed between MTCD 10 and a network 99 where information and/or textual or verbal communications can be transmitted to one or more locations remote from MTCD 10. Examples of (RCEs) from MTCD 10 include one or more of the following: Public Safety Access Points (PSAPs), private medical response service providers, private security companies and dispatchers, friends of the user, relatives of the user, taxi cab companies, other business establishments and their security desks and communication routing servers capable of transmitting information by means such as social media, e-mail, text message, instant message or other data transmission techniques communicating information to servers such as database or web servers.

As illustrated in FIG. 10, the ECAM system (hereinafter ECAM) provides a user of a COTS MTCD 10 and accompanying MTCD physical peripheral device (20, 30, 39) enhanced access to emergency communications and the ability to provide RCEs with information within user-generated audio signals, when due to pain, duress, disability, etc., the user cannot speak, hear, comprehend or respond to questions. Information provided to RCEs can include one or more of the following: user's name, gender, age, home address, work address, alternate or emergency contact information, physical attributes, medical history data, allergies, medications, GPS 2D coordinate location, GPS 3D coordinate location, GPS dilution-of-precision information, military grid reference system location, civic location, bearing information, rate of travel information, altitude, signal data from sensors in communication with the user including biomedical sensors, or indications of user-initiated events including user entry of false-alarm indicating passcodes, duress indicating passcodes, or failure to enter a passcode.

In one embodiment of the ECAM of FIG. 10, information provided by the ECAM to RCEs is provided in-band within a voice communications channel by embedding information within a user-generated audio signal. In another embodiment, information can be supplemented with out-of-band voice, data, or text communications channels individually or in combination including but not limited to: e-mail, instant message, simple message system (SMS), multimedia message system (MMS), packet data transmission, or voice-over-ip session. In select preferred embodiments, a first transmission of information can be sent prior to, subsequent to, or substantially during a second transmission using the same or a different communications channel. In some embodiments of the ECAM, information is sent to the same RCE as the RCE of the voice communication channel, e.g., a SMS or MMS is sent to a RCE capable of receiving SMS or MMS messages while also establishing a voice call containing information-carrying audio connection. In other preferred embodiments of the ECAM, information sent to a first RCE refers a human responder to a second RCE. By way of illustration, sending a URL to a first RCE via SMS that is opened to view a graphical representation of packet data sent to a second RCE; or sending information identifying the existence of an e-mail, instant message, social network feed, Really Simple Syndication (RSS) feed, or other data source accessible to at least one user associated with the RCE.

The FIG. 10 embodiment illustrates the use of a logical second peripheral 23 housed in a physical peripheral device 20 that a user can utilize to trigger the ECAM communications access procedures (CAP). With other embodiments of the ECAM, user interaction with application 16 of MTCD 10 or an interface device in communication with MTCD 10 or peripheral device (20, 30, 39) triggers the ECAM CAP. In select preferred embodiments, the triggering of the ECAM CAP causes program 16 of MTCD 10 to form outbound communications, including but not limited to dialing a series of digits and initiating an outbound phone call. In other preferred embodiments, when program 16 is restricted from initiating an outbound phone call, dialing instructions including digits are communicated by program 16 to second peripheral 23 that communicates the dialing instructions to logical first peripheral 21 such that peripheral 21 initiates a phone call procedure according to the instructions by using a hands-free peripheral communications protocol supported by MTCD 10. In another preferred embodiment of the ECAM, triggering of the ECAM CAP causes a peripheral user-generated audio source 28 in communication with a logical first or logical second peripheral (21, 23), to provide a user-generated audio signal to a peripheral. In select preferred embodiments of the ECAM, the user-generated audio signal can be communicated between logical peripherals (21, 23) and/or directly or indirectly communicated to program 16 over a peripheral-MTCD communications link 24.

When program 16 receives a user-generated audio signal over a peripheral-MTCD communications link 24, program 16 can modify the user-generated audio signal to carry at least one piece of information relevant to an emergency responder in addition to a processed form of the original audio signal. Examples of modified information associated with a user-generated audio signal can include one or more of the following: applying an automatic gain control so that the volume level of the audio is enhanced for the called party; applying a filter or equalization process that enhances the intelligibility of human speech signals; processing the audio signal using noise reduction techniques; scaling the energy of the audio signal within certain frequency bands with digital audio filters and replacing at least some of the audio signal's content in the selected frequency bands with one or more information carrying audio signals; summing the audio signal or a processed version of the audio signal with one or more information carrying audio signals; summing the user-generated audio data with information carrying audio signals that are scaled so that an instantaneous or time-windowed energy measurement of the audio data signals separately or in combination is limited to a similar energy measurement performed on the original or derived audio signal; applying a digital audio watermark to the audio signal to modify elements of the audio signal to encode computer-decodable information; and/or normalizing resulting summed signals to minimize truncation or distortion within a digital voice communication channel established with a RCE.

When program 16 does not receive user-generated audio, program 16 can generate one or more information carrying audio signals carrying information regarding an emergency situation. Examples of program 16 generated audio signals can include: tone sequences; dual-tone multi-frequency sequences; textphone standards commonly used in telecommunication devices for the deaf not limited to Baudot tones, modulated data carrier signals including frequency-shift keying, phase-shift keying, OFDM signals, spread-spectrum signals and/or human-intelligible synthetic speech signals. With respect to this preferred embodiment of the ECAM, information-carrying audio signals can be generated by program 16 or by an application associated with a peripheral device (20, 30) regardless of whether program 16 receives user-generated audio and these signals can be decoded, regenerated, modified, or overwritten by remote ECAM server endpoints including public or private branch exchange (PBX) servers supporting such operations.

In another preferred embodiment of the ECAM program 16 communicates information data values to a logical second peripheral 23 over peripheral-MTCD communications link 24. Communication of data values can occur before an outbound voice communication is established or during an outbound voice communication. When logical second peripheral 23 is directly or indirectly communicating with an audio processing means, some of the data values can control audio processing steps performed by the audio processing means including the previously enabled generation of information carrying audio signals and/or modification of user-generated audio to include information carrying signals.

In another preferred embodiment of the ECAM of FIG. 10, subsequent to the triggering of the ECAM CAP, the execution of any dialing instructions, the formation of the information-including audio signal and/or the communication of at least a portion of the information-including audio signal to logical first peripheral 21, the audio signal is provided to an audio input of the outbound voice communication channel. Logical first peripheral 21 can insert audio using a protocol compliant with at least one hands-free communications protocol supported MTCD 10 for communication over a MTCD wired peripheral interface 12 or a MTCD wireless peripheral interface 13. In select embodiments, logical first peripheral 21 can be a peripheral digital-analog converter block and analog audio output 27 outputting analog audio to a MTCD analog input and analog-digital converter block 11 of MTCD 10.

In another preferred embodiment of the ECAM, subsequent to MTCD 10 receiving information including audio signal from logical first peripheral 21, MTCD 10 transmits the audio within an outbound voice communications channel to a RCE. The voice communications channel can be transmitted via a wireless transmission over a WWAN 99 such as GSM, CDMA, LTE or other wireless telecommunications standards. Generally, the RCE is associated with a particular computer network address or set of dialed digits. However, when the RCE is a public-safety access point (PSAP) designated by a reserved set of dialed digits such as “911”, a particular set of dialed digits may not be provided to the network and instead the network receives a call with an identifier identifying the call as an emergency service call causing the network to contact an intermediary device, such as a 911 tandem, that determines the particular PSAP to route the communication to.

In a preferred embodiment of the ECAM, the user can select multiple RCEs for notification. The MTCD 10 can contact RCEs by establishing and supporting multiple outbound communications channels or by formation of a communications channel with a remote PBX server via dialing a telephone number associated with a communications interface of the PBX server or by contacting the PBX server via a computer network interface. A PBX server can contain audio decoding means and/or encoding and re-encoding means to decode and re-encode computer-decodable information included within an outbound voice communications channel formed by MTCD 10 and can filter modified audio to remove or reduce energy associated with one or more of the data carrying or human-intelligible audio signal components and/or modify the audio of the voice communications channel as previously enabled by program 16 and peripherals (20, 21, 23, 30, 39) in communication with program 16. A PBX server can create multiple versions of the audio containing different information for delivery to multiple RCEs. In select preferred embodiments of the ECAM, any of the multiple RCEs can be further bridged into conferenced audio communications channels which receive identical modified call audio or the RCEs can be bridged into semi-conferenced communication to receive different modified call audio while sending and/or receiving audio communications between RCEs.

A PBX server in communication with a PSAP resolving module can accept location information relating to and transmitted by an MTCD 10. A resolving module can provide dialing instructions to the PBX server so that the server can directly dial a PSAP serving the location of MTCD 10 or the module can directly form a gateway creating a voice communication channel with the PSAP serving the location of MTCD 10. The PSAP resolving module can contain information about the centers of the coverage areas served by each PSAP and select the appropriate PSAP based on geographic location of the MTCD 10. A novel application of the PSAP resolving module utilizes the polygonal coverage regions associated with a plurality of PSAPs to calculate the appropriate PSAP to contact. The novel application calculates the coverage region polygon containing the geographic location point reported by the MTCD 10 initiating the communications request.

In select preferred embodiments of the ECAM, the ECAM CAP can be triggered when the MTCD 10 is communicating with hands-free capable accessory device (20, 30). Some COTS MTCD's 10 operating systems can inhibit logical first peripheral 21 from controlling hands-free capabilities of MTCD 10 and/or restrict programmatic control over the selection between hands-free peripherals by program 16. By way of illustration, potential inhibitions/restrictions can be determined when communications between logical second peripheral 23 and MTCD 10 are successful and communications between logical first peripheral 21 and MTCD 10 fail. Upon detection of a failed communication, program 16 sends user profile data to an RCE using any of the following data transmission means including but not limited to connection-oriented or connectionless packet data transmission over LAN or WAN, or by encoded transmissions over transport means such as SMS, MMS or fax.

When the user of MTCD 10 unintentionally triggers ECAM CAP, the user can cancel the ECAM CAP. Cancellation can be accomplished in the following ways: accessing program 16 of MTCD 10 and inputting a passcode, passphrase, response to an authentication question, a biophysical authentication and/or a verbal passphrase to an audio peripheral device (20, 30, 39). In still other embodiments, cancellation input can be authenticated by: a logical peripheral (21, 23), program 16 or another program residing in MTCD 10, a PBX or other server or a RCE. After certain RCEs are contacted or after a predetermined time elapses, a user may not cancel the ECAM CAP.

In another preferred embodiment, a user under duress can transmit a duress indication to a RCE by entering a personal “duress passcode” that causes the MTCD 10 to generate a false cancellation without effecting operation of the ECAM system. A third-party may attempt to cancel operation of the ECAM system by entering an incorrect passcode causing MTCD 10 to transmit an “incorrect passcode” indication to RCE. Entry of a duress passcode or an incorrect passcode one or more times, removal of a SIM card, shutdown of program 16, sudden loss of communication between program 16 and logical second peripheral 23, or disablement of wireless peripheral interface 20 can cause either program 16 of MTCD 10 or an application of a peripheral device (20, 30) to issue new dialing instructions causing logical peripheral 23 or MTCD 10 to dial an emergency access number placing MTCD 10 in a special emergency services mode making malicious intervention with MTCD 10 more difficult. This preferred embodiment can be particularly useful when MTCD 10 is engineered to impede access to the SIM card, similar authentication device or battery compartment.

An event triggering use of the ECAM may be time-limited, e.g., a violent assault has ended. A user may utilize program 16 to transmit the threat of violence has ended. By way of example, a user can enter a passcode into MTCD 10 to confirm the user's status to a RCE.

In another preferred embodiment of the ECAM, a peripheral device (20, 30, 39) can include a speaker for reproducing audio received from one or more RCEs—allowing the user of peripheral device (20, 30, 39) to verbally communicate cancellation procedures and descriptions of time-limited events to a human associated with an RCE. In another preferred embodiment, the user can switch the operating mode of the MTCD 10 from hands-free to locally operated mode—allowing the user to verbally communicate cancellation procedures and descriptions of time-limited events via the MTCD's 10 microphone/speaker to a human associated with an RCE, or alternatively, when supported by RCE, the user can communicate cancellation procedures and descriptions of time-limited events by text or data communications channels to the RCE.

After a time-limited emergency event, program 16 can visually or audibly prompt the user to enter opinions and facts about the emergency event. Program 16 can transmit the collected facts and opinions to a RCE as well as geographic location of the MTCD 10 and/or user biophysical data.

In another preferred embodiment of the ECAM, the ECAM system can alert others to contact the ECAM user's MTCD 10. Implementations of MTCD 10 can enable program 16 and/or logical first peripheral 21 to utilize a do-not-disturb mode such that all inbound communications to MTCD 10 are rejected during an ECAM communications session. During an ECAM communications session, program 16 or logical first peripheral 21 can notify the sender of the inbound communication that the inbound communication is rejected.

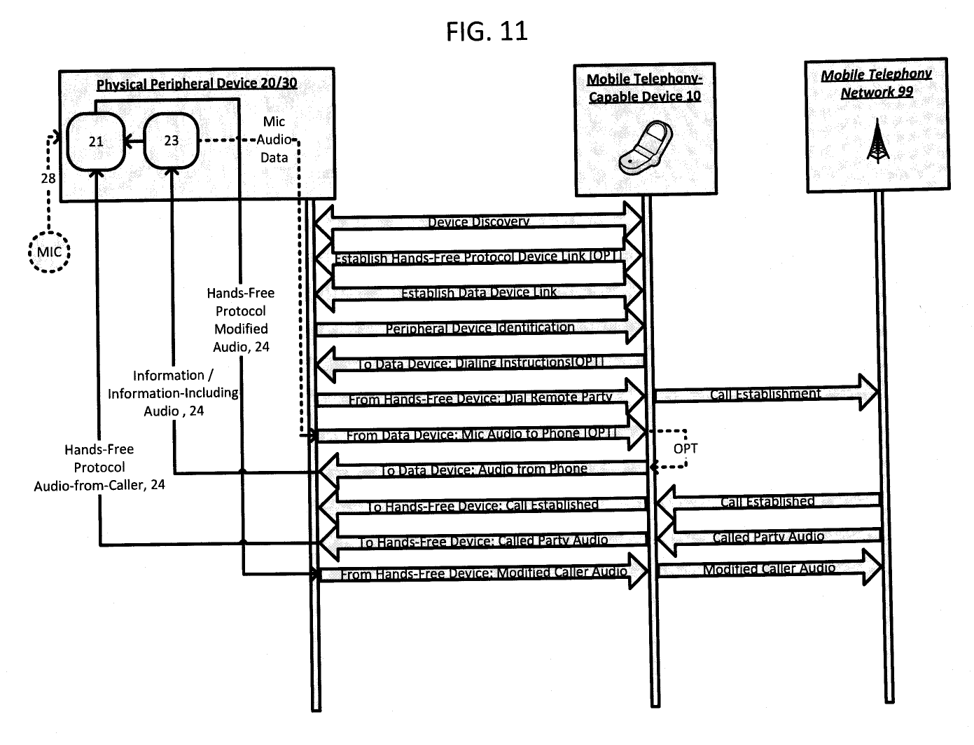

FIG. 11 illustrates a call establishment sequence describing the establishment of a telephone call using preferred embodiments of the current system. After the initiation via interaction with the MTCD 10, a peripheral device (20, 30, 39) or a non-peripheral device in communication with MTCD 10 and/or devices (20, 30, 39), wireless peripheral device 20 can discover the logical peripherals (21, 23) associated with a physical peripheral device (20, 30, 39). When wireless peripheral device 20 cannot be discovered, program 16 can interact with the operating system of MTCD 10 attempting to form a communications link with a peripheral device (20, 30) by using identifiers discovered during a testing, provisioning, or other process supported by the peripheral device. In another preferred embodiment, wireless peripheral device 20 can store identifiers from a previous testing, provisioning, or other process in a non-volatile memory such that peripheral device 20 attempts to create a communications link with MTCD 10. Logical first peripheral 21 can form a hands-free protocol compliant communications link with MTCD 10, e.g. a Bluetooth™ Hands-Free Profile (HFP) compliant link. Formation of a link between a peripheral device 20 and MTCD 10 can require an authentication or authorization process that can be aided by out-of-band communications links, e.g., Near-Field Communication (NFC)-based communications links for some implementations of the Bluetooth™ pairing process. Thus, although not disclosed in FIG. 11, the formation of communication links can include the formation of other distinct physical or logical communications channels to establish inter-peripheral or peripheral-MTCD communications links.

Referring again to FIG. 11, a second physical communications link or a second logical communications link within the first physical communications link between MTCD 10 and peripherals (20, 30) is formed. The second link is formed either concurrently or sequentially between MTCD 10 and a logical second peripheral 23 using a data transmission protocol supported by MTCD 10 for communication of data between MTCD programs and logical peripherals (21, 23) when the data contains data packet specifications enabling insertion of arbitrary data into at least a portion of certain packets. Non-limiting examples of arbitrary data protocols include Bluetooth™ profiles such as Serial Port Profile (SPP), Human Interface Device (HID) Profile, Advanced Audio Distribution Profile (A2DP) Profile, Personal Area Networking (PAN)-compliant Profiles. In another preferred embodiment, the second communications link can be formed via a wired or wireless LAN or WAN 99 packet data connection between logical second peripheral 23 and MTCD 10.

In a preferred embodiment of the call establishment sequence peripheral devices (20, 30, 39) are identified to MTCD 10. Identification of peripheral devices (20, 30, 39) can include transmissions of and acknowledgement to the following data elements: device IDs; manufacturer IDs; device model numbers; device revision numbers; device serial numbers; peripheral ID numbers; peripheral model numbers; peripheral revision numbers; local MTCD and/or remote server account IDs stored within a storage means of the peripheral device; user profile data associated with the physical device or with one of the device's IDs; hashes of passwords, pins; other authentication requests required to terminate operation; and/or operational status indicating if the device activation is intended to initiate a test of the device or of the systems in communication with the ECAM entirely or in part.

In another preferred embodiment of the call establishment sequence, MTCD 10 can communicate dialing instructions to a logical second peripheral 23. This embodiment is particularly useful when program 16 of MTCD 10 is restricted from performing some or all of its functions. Dialing instructions can include: number sequences including domestic and international dialing codes, one or more timeout values or ring counts controlling the length of a dialing attempt before termination or redialing and/or a number of retry attempts for each or all of the number sequences. In a further embodiment, logical second peripheral 23 communicates the dialing instructions or a subset of dialing instructions to a logical first peripheral 21 that uses a hands-free protocol to cause MTCD 10 to perform a call establishment sequence with a RCE.

A preferred embodiment of the information-including audio formation processes can utilize a peripheral user-generated audio source 28 in communication with logical second peripheral 23 to provide a peripheral (20, 30, 39) with user-generated audio. This information can optionally be communicated to program 16 that forms an information-including audio signal data returned to second peripheral 23. In another preferred embodiment of the call establishment sequence, program 16 communicates an information-including audio signal data to logical second peripheral 23 where an audio processing means communicating with logical second peripheral 23 processes the user-generated audio signal to include the information-including signal component(s). In other embodiments, program 16 can communicate information data to logical second peripheral 23 where an audio processing module communicating with logical second peripheral 23 performs the steps of including the information data and the user-generated audio signals into a single information-including audio signal. Within the scope of the current system, audio processing modules can be an integrated functionality of program 16 or one or more peripherals (20, 30, 39) or logical peripheral applications (21, 23), or audio processing modules can be independent of but in communication with MTCD 10 programs 16 and/or one or more of the peripherals (20, 21, 23, 30, 39).

In a preferred embodiment of the call establishment sequence, when a call is established between MTCD 10 and a RCE, the information-carrying audio signal is encoded into a format specified by the hands-free protocol used by logical first peripheral 21 and audio is delivered to MTCD 10 for repackaging and transmission via a communications channel established with at least one RCE.

When communications with a RCE are terminated prematurely, MTCD 10 can provide a premature termination message to logical first peripheral 21 that initiates a new dialing procedure. Alternatively, program 16 can sense that communications were terminated prematurely and notify logical second peripheral 23 that provides final call termination and new dialing information to logical first peripheral 21. In a further embodiment of the call establishment sequence, program 16 responds to premature termination and institutes new dialing procedures independently of logical first peripheral 21.

Within the scope of the current system, user input modalities accepted by program 16 can include: tactile button inputs of MTCD 10 including keyboards or keypads, human interface device peripherals in communication with MTCD 10 including mice, keyboards or styluses, touchscreen input devices of MTCD 10, audio-input and speech-recognition interfaces of MTCD 10 or of peripherals (20, 30, 39) associated with MTCD 10.

Program 16 of the current system is capable of communicating any of a plethora of emergency events including but not limited to: current events, completed events, criminal events, traumatic events and/or medical events. Select preferred embodiments of program 16 can process and store the following information: need of medical assistance, weapons utilized, number of people including approximate biophysical characteristics, victims, witnesses and vehicles (color, make, model, year, license number). Examples of biophysical characteristics can include sex, age, height, weight, hair color (occurrence, length, placement), eye color, skin color, use of artificial enhancements (eyeglasses, hearing aids, prosthetics, etc.) and/or body markings and scars. With respect to an at-large perpetrator, select preferred embodiments of program 16 allow MTCD 10 to generate a visual facial composite by utilizing interchangeable facial templates of the alleged perpetrator. Examples of interchangeable facial templates include but are not limited to facial contours, skin colors and tones, ear positions and shapes, hair styles and colors, eye socket contours, eyewear types and shapes, eyebrow styles, nose shapes, mouth shapes, lip colors, moustache or beard styles and/or jewelry.

Within the scope of the current system, peripheral devices (20, 30, 39) can alert the user to the status of the system, components, communication channels and/or RCEs via visual, audible, thermal, vibrational and/or other tactile alerting means associated with either MTCD 10 or peripheral device (20, 30) and any logical peripheral 21, 23 associated with peripheral device (20, 30).

Embodiments of the current system disclosed herein do not limit audio processing means to information-including processes or to processing signal data destined for outbound communications channels and the audio processing means can be adapted to perform information decoding operations on in-bound communication channels. By way of illustration, preferred embodiments of the ECAM illustrated in FIG. 10 can transmit prompts to an emergency responder at a RCE requesting the emergency responder to press a series of touch-tone keys to indicate the emergency responder's status. Examples of responder's status include: presence on the line, intention to respond, and estimated time-of-arrival (ETA) at the MTCD's 10 reported location. Subsequent to each key-press, the PBX server, audio processing means associated with the MTCD 10, program 16 or peripheral device(s) (20, 30, 39) can decode, e.g., one or more dual-tone multi-frequency encoded key-presses and/or re-encode such information to alert the user of the MTCD 10 of emergency related information including the emergency responder's ETA. Alerting means for MTCD 10 and/or peripheral devices (20, 30, 39) can include: audible or vibrational alerts (serial, Morse code-like, preselected patterns, upward or downward ramping of frequencies, etc.) In another preferred embodiment, information can be relayed back to program 16 via any means of accepting data from RCEs supported by MTCD 10 including but not limited to the following: SMS, MMS, e-mail and/or interne packet-based communications protocols. In addition, the inability to receive or decode responder status within predetermined time limits can cause program 16 and/or peripheral devices (20, 30, 39) to terminate a call, to alert the user of a premature call termination using available alerting means, and/or to establish a new communication between MTCD 10 and a RCE.

The present system is compatible with currently available COTS MTCDs 10 and is functional with various geographic embodiments of available worldwide networks. Because of the diversity of networks 99 and COTS MTCDs 10 compatible with the system, the diversity, amount, quality and regularity of information provided to RCEs can depend on factors such as: computer processing capabilities of MTCD 10, peripheral interface employed by MTCD 10, processing capabilities of MTCD 10 physical peripheral devices (20, 30, 39) and the latency, robustness, bandwidth or costs associated with the medium of communications employed by the MTCD 10 in communicating with any peripheral or RCE.

RCEs contacted by embodiments of the current system can utilize different means for information reception and information display, and the means of information delivery can change depending on whether support for a certain form of information delivery is known to be supported by a RCE. By way of illustration, a preferred embodiment of the ECAM system illustrated in FIG. 10 can utilize program 16, a peripheral device (20, 30, 39) or remote system in communication with program 16 to store information about RCEs contactable during emergencies such as whether a RCE is capable of accepting and displaying imagery transmitted via MMS or a packet-data means.

Depending on the preferences of a user of the ECAM, information delivered to a RCE can be distributed to other ECAM users or respondents and is changeable in availability and form as a function of a device receiving an ECAM alert signal. Information alerting an ECAM user can also be changed on the basis of the following: geographic proximity to the alert initiating ECAM source, ETA as measured by location and rate of travel sensors, gender, age and/or a synthesizer's speech signal simulating gender opposite of the ECAM initiator within the modified call audio is delivered to increase intelligibility of both the synthetic speech and the user-generated audio if the signals overlap in time.

Preferred embodiments of the current system can utilize MTCDs 10 that perform data and telephony functions over internet-protocol networks 99 and any internet access medium supported by MTCD 10 instead of the WWAN 99 illustrated in the Figures. Select preferred embodiments of the current system can contact remote telephony network endpoints or data network endpoints via any number of intermediary endpoints such as but not limited to 911 tandems and/or PBXs. When medical parameters require, the current system is adaptable to initiate nonemergency responses such as the summonsing of an nonemergency responder, e.g., program 16 can eliminate PSAP communications attempts and MTCD 10 contacts non-PSAP endpoints such as residential caregivers and/or sitters.

Textphone standards commonly used in telecommunications devices for the hearing impaired are compatible with the current system. Program 16 or programs in communication with program 16 can enable the user to communicate with RCEs supporting textphone standards and can allow the user to manually enter information into the information-carrying audio signal supplementing any programmatically generated information. In other embodiments, a PBX can decode and regenerate received information such that the entire stream is displayed in a more intelligible manner on the displays supporting textphone standards. In other embodiments, program 16 or other programs of MTCD 10 in communication with program 16 can display or perform text-to-speech operations on audio-carrying information signals, not limited to textphone standards, received back from the PBX. In another embodiment, information-carrying audio can be transmitted from MTCD 10 to the PBX using a non-textphone standard, and the PBX can use data decoded from audio to generate textphone standard signals supported by a given PSAP or other remote endpoint.

Within the scope of the current system, a logical first peripheral 21 or a program 16 can cause MTCD 10 to directly dial a phone number in association with a PBX server. Redundancy and failover are offered by multiple PBX servers addressable by a variety of phone numbers or network addresses such that redundancy is offered by providing multiple phone numbers to logical first peripheral 21 or program 16 to attempt the dialing of each number in round-robin or random selection with or without replacement from a preselected list of phone numbers. Failure to contact any of the PBX servers once or multiple times results in a further fail-over such that the PBX servers are contacted by SMS, packet data, etc. or where logical peripheral 21 and/or program 16 initiate an emergency services call.

In accordance with the current system, program 16, a peripheral device (20, 30), or remote server endpoints, including PBX, can record, store or backup audio streams, data streams and/or identifiers, i.e., collected information. Web and application servers in communication with MTCD 10 or the PBX server can display at least a portion of the collected information via software web server clients not limited to web browsers, as well as streaming or downloadable access to the collected information.

For select preferred embodiments of the current system, estimated future rather than present values of geographic location for MTCD 10 are delivered to RCEs. The estimated future geographic location can be calculated using any combination of the following: approximate location, approximate bearings and approximate rate-of-travel. Calculation of estimated geographic coordinates can utilize a combination of statistical variance indication values such as GPS dilution-of-precision information values, and can be formed on the basis of fixed or variable estimates of the latency in communicating MTCD 10 location value information to a RCE. Location measurements can also utilize positioning system data including: GPS, GLONASS and/or location information derived partially or entirely from cellular network equipment such as Assisted-GPS.

For preferred embodiments of the current system, when audio signal data is exchanged between a logical second peripheral 23 and a MTCD 10, data compression can be employed on audio signal data using data compression schemes such as the so-called “lossy” and/or “lossless” schemes. When bandwidth is at a premium, elements and intermediate results of audio processing signal data can be transmitted over the peripheral-MTCD and inter-peripheral communications links in place of complete audio signal data to conserve bandwidth. By way of illustration, when user-generated audio is presented to a peripheral audio source 28, instead of transmitting a full or compressed representation from second peripheral 23 to MTCD 10, predetermined audio signal measurements can be transmitted so that the computationally intensive audio processing and information-including audio signal generation take place within MTCD 10 such that any resulting bandwidth limited audio signals need to traverse the link in only one direction.

In accordance with the Articles of the Patent Cooperation Treaty, preferred embodiments of the current system invention have been disclosed and enabled.

1-32. (canceled)

33. An emergency communications access for a mobile user (ECAM) system comprising a combination for providing an information-carrying transmission to an audio communications channel established via an existing commercial network (99) between a commercially available off-the-self (COTS) mobile telephony-capable computing device (MTCD) (10) and one or more remote communications endpoints (RCE); wherein said COTS MTCD (10) communicates with at least one of said RCEs distinct from said existing commercial network (99), and wherein said COTS MTCD (10) comprises: a MTCD (10) processor, a MTCD (10) memory, a power source, an audio interface (11), a wired peripheral interface (12), a wireless peripheral interface (13), a network interface (15), one or more programs (16) and operating system hardware interface layers (17);
said combination further comprising:
a) one or more wireless peripheral devices (20) communicating with said COTS MTCD (10), wherein at least one of said wireless peripheral devices (20) comprises: an application processor (50), an inter-peripheral communications link (25), an inter-process communications link (26), an energy source, an antenna (41), and a wireless communications physical layer (33);
b) some of said wireless peripheral devices (20) further comprising a logical first peripheral (21) and at least one of a plurality of logical second peripherals (23) communicating with said inter-process communications link (26), said application processor (50) and said operating system hardware interface layers (17); wherein:
i) said logical first peripheral (21) further comprises an audio communications means for communicating an audio signal to said COTS MTCD's outbound communication channel without communicating with said programs (16);
ii) at least one of said logical second peripherals (23) is capable of communicating with said programs (16) without said audio communications means for communicating an audio signal to said COTS MTCD's outbound communication channel;
iii) at least one of said logical second peripherals (23) exchanges data with one or more of said programs (16); and
iv) said first logical peripheral (21) causes one or more of said programs (16), said first logical peripheral (21) and/or at least one of said logical second peripherals (23) in communication with said operating system hardware interface layers (17) to generate an audio information signal representing at least one piece of information received by at least one of said logical second peripherals (23) from said COTS MTCD (10) such that subsequent to generation of said audio information signal, said logical first peripheral (21) communicates said at least one piece of information to said COTS MTCD's (10) outbound communication channel for carrying said at least one piece of information to said RCE.

34. The system of claim 33, wherein the ECAM system access is initiated by a user's interaction or said user's preselected absence of interaction with one of said wireless peripheral devices (20) or said COTS MTCD (10).

35. The ECAM system of claim 34, wherein said at least one piece of information is forwarded to one or more of said RCEs via:
a) out-of-band voice, data and/or text communication channels; and/or
b) via packet data transmission over LAN or WAN; and/or
c) encoded transmission over SMS, MMS or fax.

36. The ECAM system of claim 34, wherein, via a remote PBX server, multiple outbound communications channels are established with multiple said RCEs.

37. The ECAM system of claim 36, wherein, one of said remote PBX server's resolving modules causes said PBX server to:
a) directly dial said RCE serving a geographic location of said COTS MTCD (10); and/or
b) create a voice channel with said RCE serving a geographic location of said COTS MTCD (10); and/or
c) determine said RCE serving a geographic location of said COTS MTCD (10); and/or
d) communicate an emergency responder's estimated time of arrival to said COTS MTCD (10).

38. The ECAM system of claim 34, wherein said ECAM system calculates estimated future geographic location of said COTS MTCD (10).

39. The ECAM system of claim 34, wherein one of said programs (16) communicates current events, completed events, criminal events, traumatic events and/or medical events to one or more of said RCEs.

40. The ECAM system of claim 34, wherein said ECAM system:
a) provides status alerts to said user; and/or
b) allows said user to test operational status.

41. The ECAM system of claim 34, wherein said ECAM system is:
a) is immediately cancelled by said user after activation of said ECAM system; or
b) apparently cancelled by said user after entry of a duress passcode; or
c) cancellable prior to passage of a predetermined time; or
d) cancellable prior to establishment of said COTS MTCD's (10) outbound communication channel with said RCE.

42. An emergency communications access for a mobile user (ECAM) system comprising a combination for providing an information-carrying transmission to an audio communications channel established via an existing commercial network (99) between a commercially available off-the-self (COTS) mobile telephony-capable computing device (MTCD) (10) and one or more remote communications endpoints (RCE); wherein said COTS MTCD (10) communicates with at least one of said RCEs distinct from said existing commercial network (99), and wherein said COTS MTCD (10) comprises: a COTS MTCD (10) processor, a COTS MTCD (10) memory, a power source, an audio interface (11), a wired peripheral interface (12), a wireless peripheral interface (13), a network interface (15), one or more programs (16) and operating system hardware interface layers (17);
said combination further comprising:
a) an application processor (50) associated with at least one peripheral device (20, 30, 39), an inter-peripheral communications link (25), an inter-process communications link (26), an energy source, a plurality of logical first peripherals (21) and a plurality of logical second peripherals (23);
b) one or more wireless peripheral devices (20), wherein at least one of said wireless peripheral devices (20) comprises a wireless communications physical layer (33), antenna (41) and a first sub-combination of said application processor (50), said inter-peripheral communications link (25) and said inter-process communications link (26);
c) some of said peripheral devices (20, 30, 39) comprising one of said logical first peripherals (21, 27) and at least one of said logical second peripherals (23) communicating with said first sub-combination and said operating system hardware interface layers (17); wherein:
i) said logical first peripheral (21) further comprises an audio communications means for communicating an audio signal to said COTS MTCD's outbound communication channel without communicating with said programs (16);
ii) at least one of said logical second peripherals (23) is capable of communicating with said programs (16) without said audio communications means for communicating an audio signal to said COTS MTCD's outbound communication channel;
iii) at least one of said logical second peripherals (23) without said audio communications means for communicating an audio signal to said COTS MTCD's outbound communication channel exchanges data with one or more of said programs (16); and
iv) said first logical peripheral (21) causes one or more of said programs (16), said first logical peripheral (21) and/or at least one of said logical second peripherals (23) in communication with said operating system hardware interface layers (17) to generate an audio information signal representing at least one piece of information received by at least one of said logical second peripherals (23) from said COTS MTCD (10) such that subsequent to generation of said audio information signal, said logical first peripheral (21) communicates said at least one piece of information to said COTS MTCD's (10) outbound communication channel for carrying said at least one piece of information to said RCE; and
d) a wired peripheral device (30) comprising a wired communication physical layer (36), wherein said wired peripheral device (30) communicates with said COTS MTCD (10) via said operating system hardware interface layers (17) and a second sub-combination of said application processor (50), said inter-peripheral communications link (25) and said inter-process communications link (26); and wherein said wired peripheral device (30) is provided with an optional first audio source (28); and/or
e) an audio jack peripheral (39) comprising a digital-analog converter (27), wherein said audio jack peripheral (39) communicates with said COTS MTCD (10) via said operating system hardware interface layers (17) and a third sub-combination of said application processor (50), said inter-peripheral communications link (25) and said inter-process communications link (26); and wherein said audio jack peripheral (39) is provided with an optional second audio source (28).

43. The system of claim 42, wherein the ECAM system access is initiated by a user's interaction or said user's preselected absence of interaction with one of said wireless peripheral devices (20), said wired peripheral device (30), said audio jack peripheral (39) or said COTS MTCD (10).

44. The ECAM system of claim 43, wherein said at least one piece of information is forwarded to one or more of said RCEs via:
a) out-of-band voice, data and/or text communication channels; and/or
b) via packet data transmission over LAN or WAN; and/or
c) encoded transmission over SMS, MMS or fax.

45. The ECAM system of claim 43, wherein, via a remote PBX server, multiple outbound communications channels are established with multiple said RCEs.

46. The ECAM system of claim 45, wherein, one of said remote PBX server's resolving modules causes said PBX server to:
a) directly dial said RCE serving a geographic location of said COTS MTCD (10); and/or
b) create a voice channel with said RCE serving a geographic location of said COTS MTCD (10); and/or
c) determine said RCE serving a geographic location of said COTS MTCD (10); and/or
d) communicate an emergency responder's estimated time of arrival to said COTS MTCD (10).

47. The ECAM system of claim 43, wherein said ECAM system calculates estimated future geographic location of said COTS MTCD (10).

48. The ECAM system of claim 43, wherein one of said programs (16) communicates current events, completed events, criminal events, traumatic events and/or medical events to one or more of said RCEs.

49. The ECAM system of claim 43, wherein said ECAM system:
a) provides status alerts to said user; and/or
b) allows said user to test operational status.

50. The ECAM system of claim 43, wherein said ECAM system is:
a) is immediately cancelled by said user after activation of said ECAM system; or
b) apparently cancelled by said user after entry of a duress passcode; or
c) cancellable prior to passage of a predetermined time; or
d) cancellable prior to establishment of said COTS MTCD's (10) outbound communication channel with said RCE.

51. The ECAM system of claim 43, wherein said COTS MTCD (10) further comprises:
a) a data-over-audio interface (14); and/or
b) a wired hands-free protocol supporting at least one of said logical second peripherals (23) communicating instructions to said one logical first peripheral (21) initiating said COTS MTCD's (10) outbound communication channel for carrying said at least one piece of information to said RCE.

52. The ECAM system of claim 43, wherein subsequent to initiation of said ECAM system, said ECAM system is continued when:
a) one of said logical second peripherals (23) of said wireless peripheral devices (20) forms a communications link with one or more said logical second peripherals (23) contained within one of said wired peripheral devices (30,39); or
b) one of said logical second peripherals (23) waits until one or more said logical second peripherals (23) contained within one of said wired peripheral devices (30,39) forms a communication link; or
c) one of said logical second peripherals (23) of said wireless peripheral devices (20) forms a communications link with one of said programs (16); or
d) one of said logical second peripherals (23) waits until one of said programs (16) forms a communication link.

53. The ECAM system of claim 43, wherein one of said wireless peripheral devices (20) communicates with:
a) one of said programs (16) via said wireless interface (13);
b) said audio jack device (39) via said inter-peripheral communications link (25); and
c) one of said logical second peripherals (23) associated with said audio jack device (39) in wired communication with said COTS MTCD (10).

54. The ECAM system of claim 51, wherein one of said wireless peripheral devices (20) communicates with one of said programs (16) via:
a) said inter-peripheral communications link (25) communicating with one of said logical second peripherals (23) associated with said wired peripheral device (30) in wired communication with said COTS MTCD (10); or
b) said wireless interface (13) and with said wired peripheral device (30) via said inter-peripheral communications link (25) with one of said logical second peripherals (23) associated with said wired peripheral device (30) in wired communication with said COTS MTCD (10); or
c) said inter-peripheral communications link (25) communicating with one of said logical second peripherals (23) associated with said audio jack device (39) in wired communication with said COTS MTCD (10).

55. The ECAM system of claim 51, wherein:
a) from said first audio source or said second audio source (28), said application processor (50) receives audio and communicates said audio to one of said logical second peripherals (23) communicating said audio via said communications link (24) to one of said programs (16) that generates said at least one piece of information including audio data and returns said at least one piece of information to said logical second peripheral (23) for forwarding to said logical first peripheral (21) via said inter-peripheral communications link (25); or
b) from said first audio source or said second audio source (28), said application processor (50) receives audio measurements and communicates said audio measurements to one of said logical second peripherals (23) communicating said audio measurements via said communications link (24) to one of said programs (16) that generates said at least one piece of information including audio measurements data and returns said at least one piece of information to said logical second peripheral (23) for forwarding to said logical first peripheral (21) via said inter-peripheral communications link (25).

56. The ECAM system of claim 51, wherein said wired peripheral device (30) communicates:
a) with one of said programs (16) via said wired peripheral interface (12), and via said inter-peripheral communications link (25), with one of said logical peripherals (23) associated with one of said wireless peripheral devices (20); or
b) with one of said programs (16) via said wired peripheral interface (12), and via said inter-peripheral communications link (25), with said audio jack peripheral device (39) in communication with said audio interface (11).

57. The ECAM system of claim 51, wherein:
a) said audio jack peripheral device (39) utilizes said digital-analog converter (27) to communicate with one of said programs (16) via said data-over-audio interface (14); and
b) one of said second logical peripherals (23) associated with one of said wireless peripheral devices (20), via an inter-peripheral communications link (25), communicates with said audio jack peripheral device (39).

58. The ECAM system of claim 52, wherein at least one of said wireless peripheral devices (20), said wired peripheral devices (30) or said one audio jack peripheral devices (30) comprises an audible or vibrational alert.

59. The ECAM system of claim 52 wherein said outbound communication includes textual, verbal or textual and verbal data.

60. An emergency communications access for a mobile user (ECAM) system comprising a combination for providing an information-carrying transmission to an audio communications channel established via an existing commercial network (99) between a commercially available off-the-self (COTS) mobile telephony-capable computing device (MTCD) (10) and one or more remote communications endpoints (RCE); wherein said COTS MTCD (10) communicates with at least one of said RCEs distinct from said existing commercial network (99), and wherein said COTS MTCD (10) comprises: a COTS MTCD (10) processor, a COTS MTCD (10) memory, a power source, an audio interface (11), a wired peripheral interface (12), a wireless peripheral interface (13), a network interface (15), one or more programs (16) and operating system hardware interface layers (17);
said combination further comprising:
a) a wired peripheral device (30) communicating with said COTS MTCD (10), wherein said wired peripheral device (30) comprises: a first application processor (50), a first inter-peripheral communications link (25) and inter-process communications link (26), a first energy source, a first antenna (41), a first optional first audio source (28), a wired communications physical layer (36), a logical first peripheral with data support (22) and a first logical second peripheral (23) communicating with said first inter-peripheral communications link (25) an inter-process communications link (26), said first application processor (50) and said operating system hardware interface layers (17); wherein:
i) said logical first peripheral with data support (22) further comprises an audio communications means for communicating an audio signal to said COTS MTCD's outbound communication channel;
ii) said first logical second peripheral (23) is capable of communicating with said programs (16) via data messages forwarded by said logical first peripheral with data support (22);
iii) said first logical second peripheral (23) exchanges data with one or more of said programs (16) via said data messages; and
iv) said first logical peripheral with data support (22) causes one or more of said programs (16), said first logical peripheral with data support (22) and/or said first logical second peripheral (23) in communication with said operating system hardware interface layers (17) to generate an audio information signal representing at least one piece of information received by said first logical second peripheral (23) from said COTS MTCD (10) such that subsequent to generation of said audio information signal, said logical first peripheral with data support (22) communicates said at least one piece of information to said COTS MTCD's (10) outbound communication channel for carrying said at least one piece of information to said RCE.

61. The system of claim 60, wherein said combination further comprises a wireless peripheral device (20) communicating with said wired peripheral device (30); said wireless peripheral device (20) comprising:
a) a second application processor (50);
b) a second inter-peripheral communications link (25);
c) a second energy source;
d) a second antenna (41);
e) a second optional second audio source (28);
f) a wireless communications physical layer (33), and
g) a second logical second peripheral (23) communicating with said first logical second logical peripheral (23) of said wired peripheral device (30) via said second inter-peripheral communications link (25).
